(19) United States
(12) Patent Application Publication
(10) Pub. No.: US 2021/0131337 A1
(43) Pub. Date: May 6, 2021

(54) Alcohol And Plasma Enhanced Prechambers For Higher Efficiency, Lower Emissions Gasoline Engines

(71) Applicant: Massachusetts Institute Of Technology, Cambridge, MA (US)

(72) Inventors: Leslie Bromberg, Sharon, MA (US); Daniel R. Cohn, Cambridge, MA (US)

(21) Appl. No.: 16/638,780

(22) PCT Filed: Aug. 21, 2018
(86) PCT No.: PCT/US2018/047220

§ 371 Date: Feb. 13, 2020

Related U.S. Application Data
(60) Provisional application No. 62/550,191, filed on Aug. 25, 2017.

(51) Int. Cl. F02B 19/12; F02D 19/08

(52) U.S. Cl. CPC F02B 19/12; F02D 19/0689; F02D 19/084

(57) ABSTRACT

Optimized alcohol and plasma enhanced prechambers for engines powered by gasoline and other fuels are used to increase the range of prechamber operation and to reduce soot. The increased prechamber capability is employed to extend the limit of lean operation of the engines. It can also be used to extend the limit of heavy EGR operation and to enable higher RPM operation. The amount of alcohol used in the prechamber is preferably less than 2% of the fuel that is used in the engine cylinder. The alcohol for the prechamber can be entirely provided by onboard separation from a gasoline-alcohol fuel mixture.

This application claims priority to U.S. Provisional Patent Application Ser. No. 62/550,191, filed Aug. 25, 2017, the disclosure of which is incorporated herein by reference in its entirety.

### BACKGROUND OF THE INVENTION

There is a pressing need to develop new approaches for more efficient, and cleaner gasoline engines that are affordable for large scale market penetration.

An important factor is the increasing worldwide concern about the adverse air quality impact of diesel engine emissions of NOx and particulates. Diesel engines require costly and complex exhaust after treatment systems as well as low sulfur fuel in order to reduce emissions and meet regulations. Even with these exhaust after treatment systems, diesel engine emissions are still much greater than those from gasoline engines and reducing diesel engine vehicle emissions beyond the present levels is very challenging.

A promising approach that has been previously pursued is the use of a prechamber for spark ignition gasoline engines where a stratified rich fuel-air mixture is combusted and provides a flame that enables ultra-lean operation in an engine cylinder. The engine cylinder is the main chamber. Each cylinder in the engine can have a prechamber. The ultra-lean operation in the Otto cycle engine significantly increases efficiency and reduce engine-out emissions, especially of NOx.

However, present prechamber means of enabling these ultra-lean mixtures have issues of soot production and combustion stability that limit their capability for achieving considerably lower NOx emissions and higher efficiency.

Prechamber operation involves the use of a hot rich mixture of fuel and air that is spark ignited in the prechamber and expands into the main cylinder through holes separating these two regions. This creates ignition over a relatively large region in the main cylinder.

Relative to stratified injection without a prechamber, an important advantage of the prechamber is that it is substantially easier to control the conditions of two separate regions, one that is optimized for ignition and early phase combustion (0-10% burn of the fuel), and the second one optimized for efficiency and/or emissions, combusting the majority of the fuel (10-90% burn of the fuel). The combustion stability is usually determined by the 0-10% fuel combustion, while the efficiency of the combustion is determined by the combustion of the 10-90%.

A number of prechamber approaches have been previously explored. A particularly promising approach is a torch-like ignition which is referred to as “turbulent jet ignition”.

In this approach, multiple narrow channels are used to exhaust combustion products from the prechamber into the cylinder.

The improvement in combustion provided by prechamber enabled stratified combustion can make possible substantial improvements in fuel efficiency, and engine-out emissions. Efficiency improvements of ˜20%, and NOx emissions as low as 10 ppm using ultra-lean operation (which occurs at around half or less than half of the fuel to air ratio for a stoichiometric fuel-air ratio) have been reported.

Sufficiently low NOx emissions level may potentially make it possible to meet regulations without use of complex and costly urea-SCR technology that is used for lean operation in diesel engines.

However, there are still shortcomings with existing prechamber approaches that limit the ability to achieve ultra-lean operation. There are also other opportunities for using prechamber operation to enable cleaner and more efficient engine operation.

### SUMMARY OF THE INVENTION

Features of new prechamber approaches that would optimally employ a very small amount, preferentially less than 2% of the total fuel used, as alcohol (ethanol or methanol) in the prechamber are disclosed. These features remove present limitations on prechamber operation.

Use of an optimized prechamber with a rich fuel/alcohol-air mixture and/or an optimized plasma ignition source can provide a means to enable more robust ultra-lean operation in gasoline engines, including operation at lower equivalence ratios with lower generation of NOx.

An alcohol-enhanced prechamber is described which can also enable heavy EGR (exhaust gas recirculation) operation. Further, increased alcohol use can be used to increase knock resistance and enable higher RPM operation.

These benefits could be particularly useful in enabling diesel-like or better high efficiency in gasoline engines using heavy EGR operation with a stoichiometric fuel/air ratio. With the use of three-way catalyst exhaust treatment, vehicular NOx emissions could be reduced to a level that is substantially lower than NOx emissions from a diesel engine vehicle with state-of-the-art exhaust treatment technology.

To further enhance prechamber operation, plasma concepts for prechamber ignition are described that can also increase the capability of prechamber gasoline engine operation.

Relative to a prechamber that uses only gasoline, the use of alcohol and/or an optimized prechamber ignition source provides advantages of a richer fuel/air mixture (including richer than stoichiometry), faster expansion into the main chamber and soot free operation. The amount of alcohol that is required could be reduced by varying the prechamber equivalence ratio according to engine conditions, by using a variable alcohol-gasoline mixture that is directly injected into the prechamber and by use of an optimized ignition source.

Moreover, additional alcohol can used on-demand in the cylinder to provide additional knock suppression, thereby increasing engine efficiency and/or performance.

In some embodiments, methanol may be preferred over ethanol because of its higher flame speed and lower propensity for sooting.

The alcohol can be provided by external refill of a separate tank or by onboard separation from an alcohol-gasoline blend such as E10 or M15. Onboard separation of methanol from M3 might also be used but in this case the alcohol would only be used for the prechamber. The alcohol could also be obtained from alcohol-gasoline blends where there is a higher percentage of alcohol in the blend than there is in E10 or M15.

In some embodiments, the alcohol that is used for prechamber operation is entirely provided by onboard separation from an alcohol-gasoline blend.

Gasoline engines that use an alcohol-enhanced prechamber could provide significant advantages for both light duty vehicles and for medium duty vehicles that have drive cycles where most of the operation is at low torque. Relative to conventional naturally aspirated engines, the ultra-lean operation that is enabled by alcohol and/or plasma enhanced prechamber operation can provide an efficiency gain of about 20% to possibly 25% relative to light duty vehicles that are not downsized by use of turbocharging and are operated with conventional compression ratios of 10 or less.

Upspeeding gearing (operating a higher ratio of engine RPM to wheel RPM than would otherwise be used) and/or turbocharging may be used to increase engine power so as to compensate for the lower power due to lean operation. This can reduce or prevent “upsizing” efficiency loss from the ultra-lean operation. Upspeeding gearing increases engine power by higher RPM operation at a given value of engine torque. The increased engine power to torque ratio can partially or completely compensate for the lower power operation that would otherwise result from the lower torque that results from ultra-lean operation that does not use upspeeding.

Downsizing using additional turbocharging could increase this efficiency gain to around 25-28%.

These ultra-lean turbo engines could use a very small amount of alcohol (preferably less than 2% of the fuel used in the main chamber) for the prechamber. They could be particularly attractive for replacement of small diesel engines for light duty use in Europe and other places where there are plans to limit diesel engine use due to air pollution concerns.

Alternatively, engines with similar downsizing and compression ratio could be operated with gasoline turbocharged direct injection (GTDI)-like downsizing, a stoichiometric fuel/air ratio, heavy EGR and a somewhat lower efficiency gain than ultra-lean operation. The efficiency gain could be increased to a level that is comparable to or higher than a diesel engine with further downsizing enabled by additional alcohol injection in the main cylinder. The additional alcohol injection provides additional knock resistance which is equivalent to a boost in the octane number of fuel in the cylinder. In addition, vehicles with these engines and a three-way catalyst can also provide much lower NOx emissions than a diesel engine that uses a state of the art exhaust treatment system.

These engines thus employ ethanol or methanol for both “burn boost” and octane boost. “Burn boost” refers to the alcohol used in the prechamber and octane boost refers to the alcohol used in the main cylinder. The ethanol requirement for burn boost could potentially be only around 1% of the gasoline that is used.

Use of an ultra-lean engine with alcohol burn boost and if desired alcohol octane boost in a long haul heavy duty vehicle could provide significantly lower emissions than a diesel engine vehicle with state-of-the-art exhaust treatment, along with substantially lower engine and exhaust treatment cost, and higher power capability.

The alcohol requirement could be less than 2% for burn boost alone and less than 10% if alcohol octane boost were also employed.

A burn and octane boosted engine could also be an option for a medium or heavy duty vehicle natural gas engine. This engine may be around 15% greater in efficiency than present spark ignition natural gas engines (thereby providing assurance that the natural gas engines produces no more greenhouse emissions than clean diesel engines when fugitive emissions are taken into account) and also assuring that NOx emissions are a factor of ten times lower than clean diesel engines. This type of engine could be useful for stationary natural gas engine applications as well as for vehicular applications.

A burn and octane boosted gasoline engine could be used in a flex fuel alcohol-gasoline vehicle with stoichiometric operation where, for example, there is a gain in efficiency when the fuel is 100% ethanol or a high concentration ethanol blend such as E85 or E100. This gain in efficiency is provided by the use of exhaust heat recovery employing both endothermic energy recovery and a Rankine cycle and could add an additional 15-20% efficiency gain.

Use of 100% ethanol in this higher efficiency engine could reduce greenhouse gas emissions by a 35-40% relative to a diesel engine (since the lifecycle greenhouse gas emissions from a state of the art corn ethanol plant using corn from state of the art farming can be about 20% lower than greenhouse gas emissions from diesel fuel).

Higher efficiency through endothermic exhaust heat recovery and use of a Rankine cycle could also be enabled by use of 100% methanol or by a high concentration blend of methanol with gasoline.

Utilization of an optimized alcohol prechamber could play an important role in the deployment of cleaner and higher efficiency gasoline engines and significantly increase their attractiveness as alternative to diesel engines

A small alcohol prechamber added to a gasoline engine could provide a lower emissions and lower cost ultra-lean engine alternative to light duty and medium duty (e.g. delivery truck) diesel engines used in parts of Europe and other places that do not provide gasoline-alcohol mixtures at fueling stations. For this alternative to be most compelling in these regions, the alcohol requirement should probably be less than 3% and the NOx emissions should be reduced to a significantly lower level than that which can be achieved by urea-SCR.

This ultra-lean alternative would also be attractive in regions that provide low concentration alcohol fuels and its attractiveness could be increased by providing the alcohol from onboard fuel separation in countries such as the US, Brazil and China and potentially India.

The heavy EGR stoichiometric options with low alcohol requirements could be attractive worldwide as a way to provide a modest increase in fuel efficiency (˜5%) beyond that of a GTDI engine, along with a further reduction in NOx below the very low level that is obtained with use of a three-way catalyst.

The combination of heavy EGR and on-demand alcohol octane boost enabled by higher alcohol use (e.g. 10%) that is enabled by onboard fuel separation could provide an efficiency gain comparable to or greater than a diesel engine along with ultra low NOx emissions.

Alcohol prechamber enhanced engines could be used with hybrid powertrains as well as conventional powertrains. Use of an alcohol prechamber engine in a hybrid power train could enable ultra-lean operation that could provide a significant increase in hybrid vehicle efficiency and could also reduce NOx emissions. Engines operated with prechamber enabled heavy EGR operation could also be used with hybrid powertrains. The hybrid powertrains could be powertrains where the battery is only charged by electricity that is provided by a generator that is powered by the engine or plug-in powertrains where the battery is charged using electricity from an external power source.

Use of improved prechamber ignition that employs high voltage plasma sources, such as short pulse high power discharges or dielectric barrier discharges, could further improve alcohol prechamber operation. It may also offer a means to significantly improve prechamber operation without the use of alcohol.

### BRIEF DESCRIPTION OF THE DRAWINGS

For a better understanding of the present disclosure, reference is made to the accompanying drawings, in which like elements are referenced with like numerals, and in which:

FIG. 1A illustrates prechamber operation where alcohol is introduced into the prechamber. FIG. 1B illustrates prechamber operation where alcohol is introduced into the prechamber and the engine.

FIG. 2A is a schematic of cylinder, piston and prechamber. FIG. 2B shows a prechamber with conventional spark and fuel injector. FIG. 2C shows a dielectric prechamber with central sparking electrode and ring ground electrode. FIG. 2D shows a prechamber for use with dielectric barrier discharge or corona discharge.

FIGS. 3A-3B show schematics of surface barrier discharge for igniting prechamber.

FIGS. 4A-4B show surface discharge options when integrating a spark plug and a prechamber.

FIG. 5A shows temperature and pressure as a function of the equivalence ratio for an alcohol fueled prechamber. FIG. 5B shows molar composition as a function of the equivalence ratio for an alcohol fueled prechamber.

### DETAILED DESCRIPTION

### Alcohol-Enhanced Prechambers

Gasoline has generally been used as the fuel for the prechamber of a combustion engine. However, it has been determined that gasoline is not a preferred fuel to be used for combustion in the prechamber, as it has large quench thickness that adversely affects the combustion in a small prechamber chamber. In addition, allowable equivalence ratios are limited with gasoline. There is also a problem with soot production.

It is advantageous to use alcohol, such as ethanol or methanol, in the prechamber since alcohols have less of a propensity to soot and have a significantly larger range of allowable equivalence ratios. Alcohols, such as ethanol and methanol, have higher flame speed, and broader dilution limits than gasoline.

New features for prechamber operation where alcohol is used as the fuel are described below.

Prechamber volumes as low as 2% of the cylinder volume at top dead center have been used with gasoline in both the prechamber and the cylinder. With optimal design, it may be possible to use alcohol in the prechamber to provide an improvement in gasoline combustion in the cylinder along with a smaller prechamber volume than would be the case with the use of gasoline in the prechamber. It is preferred that the prechamber volume be less than 2% of the cylinder volume at top dead center.

The alcohol fuel can be obtained from a separate second tank. The second tank can be refilled from onboard separation of a component from the fuel in the main tank (gasoline/alcohol blends) and/or can be periodically refueled externally. Since the amount of the fuel (by energy) required is small, refueling operations would be infrequent.

It may be possible to use the prechamber as one element of an air-assisted injector. In this embodiment, both air and fuel are introduced in the prechamber during the air intake period and optionally during the early stages of compression. Purging of the prechamber in this embodiment is automatic, with fresh fuel and air injected and eliminating residuals from the prechamber. If there are residuals in the main chamber, some of them will be introduced into the prechamber during the compression phase. Fuel can be introduced into the prechamber, without the use of the air assist, to provide additional fuel in the prechamber.

For successful operation of the prechamber, it is necessary to vaporize the liquid fuel, without the production of soot. It may also be advantageous to use coatings on the wall to facilitate operation. These coating could be catalytic in nature.

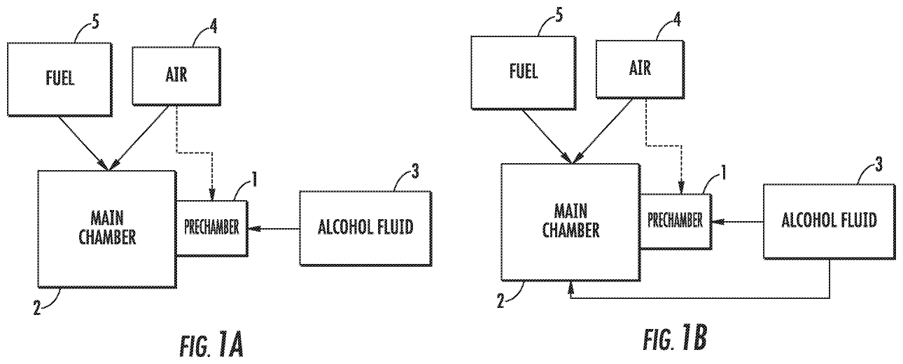

FIG. 1A illustrates prechamber operation where alcohol 3 is introduced into the prechamber 1. Air 4 can also be introduced into the prechamber 1. The main chamber 2 of the engine, also referred to in this disclosure as the cylinder, is fueled with gasoline or another fuel 5 (e.g. natural gas) and operates with high dilution (ultra-lean or heavy EGR operation).

In the ultra-lean mode, the addition of the alcohol 3 will enable operation of the main chamber 2 with a lower fuel/air equivalence ratio (higher lambda) than would otherwise be possible with gasoline. Lean operation (high dilution) is limited by variability of combustion. When the variability, usually measured as Coefficient of Variability of Indicated Mean Equivalent Pressure (COV of IMEP), is high, there is a noticeable change in the engine/vehicle operation. Usually, the COV of IMEP, for stable operation, should be less than 5%. For typical gasoline operation, the stability limit for lean combustion occurs at a lambda (air/fuel ratio related to stoichiometric air fuel ratio) of 1.5-1.6. With the use of optimized alcohol-enhanced prechamber assisted ignition, the amount of dilution that would still provide stable combustion could be increased to a lambda of 2-2.2 or more. By comparison, the lean limit when gasoline is used in the prechamber is about 1.9-2. The relative small increase in air fuel ratio with respect to the gasoline lean limit is important in that it can result in a very large drop in NOx production.

There is also an improvement in efficiency with leaner operation, resulting in lower pumping losses at light loads, as well as reduced heat transfer to the cylinder walls, improving engine efficiency.

However, at ultra-lean operation, efficiency starts to drop with conventional sparking because of slow rate of combustion. Use of a prechamber, which starts the combustion over a large volume, results in reduction in combustion time C10-90, defined as the time between combustion of 10% and 90% of the fuel. Although the above discussion applies to lean operation, other forms of dilute operation similarly benefit from the use of a prechamber, such as operation with high rates of EGR.

An additional option, as shown in FIG. 1B, is to employ increased alcohol use to prevent knock by on-demand alcohol octane boosting. During conditions of high load, the alcohol 3 may be introduced on demand into the main chamber 2 when needed to prevent knock. For knock control, it may be beneficial to directly inject the alcohol 3 into the main chamber 2, in order to take advantage of the evaporative cooling of the alcohol 3. Alternatively, the alcohol 3 could be injected using open-valve port fuel injection which provides evaporative cooling but not as much direct injection. In some embodiments, closed-valve port fuel injection may also be employed. In these conditions, there can be alcohol in different concentrations relative to gasoline both in the main chamber 2 and in the prechamber 1. Alternatively, 100% alcohol or the same alcohol-gasoline mixture could be used in both the prechamber and the cylinder,

### Alcohol and Plasma Enhanced Prechamber Design

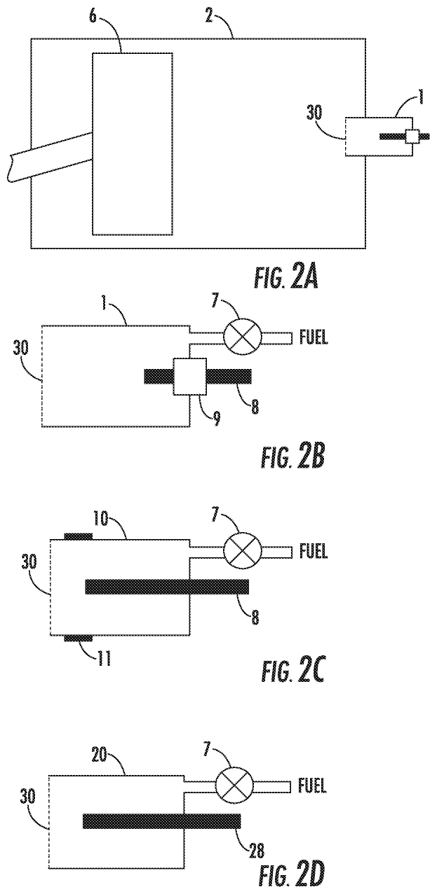

An illustrative design for a small prechamber that uses ethanol or methanol is shown in FIGS. 2A-2D. FIG. 2A shows the schematic of a cylinder (also referred to as the main chamber 2), the piston 6 and the prechamber 1. FIG. 2B shows the prechamber 1 for a conventional spark and fuel injector. The prechamber 1 is in communication with a valve 7 used to meter fuel to the prechamber 1. A central sparking electrode 8 also extends into the prechamber 1. The central sparking electrode 8 may be separated from the walls of the prechamber 1 through the use of an insulator 9. In this embodiment, the walls of the prechamber 1 may be electrically conductive. FIG. 2A shows an interface 30 between the main chamber 2 and the prechamber 1. This interface 30 comprises a surface having holes or orifices and is disposed at the end of the prechamber 1. The orifices provide communication between the prechamber 1 and the main chamber 2. One or more orifices can be used, as described below.

Prechamber operation could be enhanced by use of an optimized plasma source for creating prechamber ignition, and catalytic surfaces in the prechamber. In this disclosure, a plasma source is any source of electrically conductive gas. The catalytic surfaces can be optimized for combustion or for reforming (converting the alcohols into hydrogen rich gas). Alcohols, which have much lower potential for sooting, are more practical than gasoline, which would form soot on the catalyst surfaces.

Conventional spark plugs, with two electrodes separated by a gap, can be used as the sparking mechanism in the prechamber. Other sparking mechanisms, different from a spark plug, can alternatively be used. FIG. 2C shows a prechamber 10 with a plasma source made of a dielectric material having a central sparking electrode 8 and a ring ground electrode 11. The ring ground electrode 11 is disposed outside the prechamber 10. FIG. 2D shows a prechamber 20 for use with dielectric barrier discharge of corona discharge. In this embodiment, the central sparking electrode 28 is operated at high voltage using AC voltages. Any of these prechambers could be placed where the spark plug is presently placed on the engine.

A high voltage, short duration plasma source is preferred. In other words, a short duration, such as nanosecond to microseconds, in contrast to a high current, long duration plasma source, may be preferable. Use of this type of plasma source could increase the spark lifetime and result in very fast combustion in the prechamber. If the reaction is very fast, enabled by the use of high power, high voltage, short pulse discharges, it is likely that the generation of soot in the prechamber is decreased, as soot building requires time for nucleation and growth of the particles.

In addition, any soot generated in the prechamber 1 may be burned in the main chamber 2, as the main chamber 2 may have excess oxygen. It is advantageous that the prechamber 1 does not accumulate soot.

The use of a better ignition source in the prechamber 1 can significantly improve the operation with gasoline as the fuel in the prechamber 1 as well as operation with alcohol. In other words, in some embodiments, the prechamber 1 is fueled with alcohol. In certain embodiments, the prechamber 1 is fueled with alcohol and an optimized plasma source is used for creating prechamber ignition. In yet another embodiment, the prechamber 1 is fueled with gasoline or a gasoline/alcohol mix and an optimized plasma source is used for creating prechamber ignition.

The amount of alcohol that is required for prechamber operation could be minimized by using an optimized combination of the ignition source and fraction of fuel in the prechamber 1 that is provided by fuel in the main chamber 2 that is inducted into the prechamber 1 during the compression cycle. It could be possible to use an alcohol-gasoline mixture in the prechamber 1 rather than 100% alcohol in order to achieve the important advantages of using alcohol in the prechamber 1.

It could be advantageous to electrically ignite the fuel in the prechamber 1 in the region of the prechamber where the hot gas exits from the prechamber (i.e. near the orifices). In this manner, fluid that has combusted will be preferentially introduced into the main chamber 2 from the prechamber 1. Alternatively, the ignition region could be located away from the exit region, and combustion in the prechamber 1 occurring in a time period that is small compared to the prechamber emptying time.

An alternative to a small ignition volume spark plug is to use a large extended discharge in the prechamber that provides ignition over a large fraction of the volume of the prechamber. High voltage, low current discharges would be preferable for electrode erosion minimization.

For the high voltage nanosecond discharges, voltages higher than 40 kV would be preferable.

It is possible to choose among several sparking techniques that provide high voltage, short pulse discharges that deliver substantial power over short periods of time (on the order of nanoseconds). These discharges have been found to be useful for igniting hard to ignite mixtures, without the use of the prechamber. In the case of the prechamber, kernel formation is less of an issue than in present spark ignited gasoline engines, due to the small volume. The presence of arc/glow after the high voltage discharge is less of an advantage than when a spark is trying to ignite the main chamber.

A high voltage discharge, before it switches to an arc or a glow discharge, may be preferable. The high voltage discharges occupy a larger fraction of the volume of the prechamber, as opposed to the conventional spark discharge (glow), which constricts to a narrow channel.

The energy delivered by the plasma ignites the fuel by the radical production and/or by thermal heating of the air-fuel mixture. Shielded spark plugs and cables, or coil-on-plug, can be used to minimize EMI (electromagnetic interference). Preferably, the spark plugs will not include a resistor (which is used in conventional spark plugs for minimizing EMI). The source of the energy could be either capacitive or inductive.

The very high power delivered during the high voltage discharge delivers relatively low energy, but it is more efficient in driving reactions. Making it longer does not particularly help the performance, as once the reaction has taken place, additional electrical energy in the prechamber is not particular effective. Discharges that are longer than the emptying time of the prechamber result in wasted energy. High voltage, high power sparking can be the most effective means of delivering the required ignition energy.

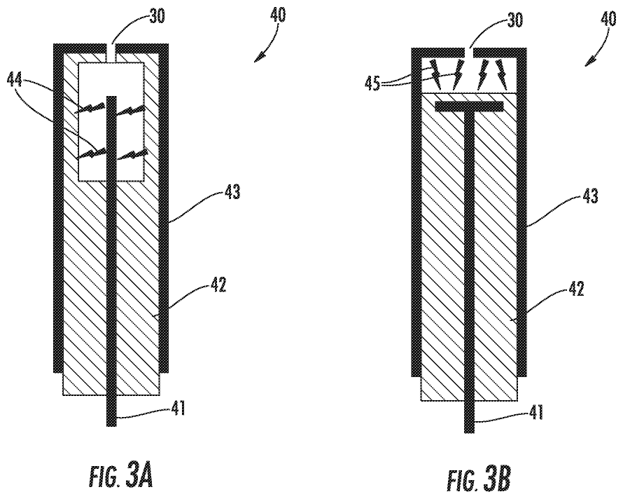

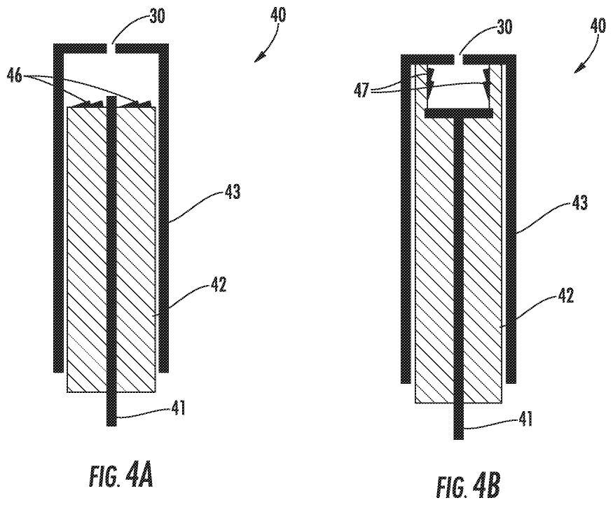

Dielectric barrier discharges (also known as silent discharges), at high frequency, such as greater than 100 kHz, could also be used, as shown in FIGS. 3A-3B and 4A-4B. Corona discharges could also be used. Dielectric barrier, corona discharges and high voltage, pulsed discharges have non-thermal properties generating radicals that can efficiently ignite the prechamber.

Use of a surface barrier discharge can be advantageous. This type of discharge occurs when there is a dielectric between the two electrodes, as shown in FIG. 2C and FIGS. 3A-3B and 4A-4B. These discharges are AC, as described below. When the voltage on one polarity is high enough, there is a breakdown in the gap that generates an electron steam marching towards the opposite electrode (which is referred as a “steamer”). However, because of the presence of the dielectric, the discharge stops when the charges in the dielectric are high enough to reduce the electric field below a threshold. Multiple streamers occur, spatially separated, charging different regions of the dielectric. When the polarity of the electrode reverses, the opposite phenomena occurs, again with multiple streamers. The possibility of using this type of discharge is enabled by the use of the prechamber.

The duration of the streamers depends on the geometry of electrodes and on the power supply. The streamers, however, are usually from a few hundreds of nanoseconds to 1 microsecond. A large number of streamers can coexist, generating ignition points for combustion of the fuel rich mixture in the prechamber.

Catalysts can be deposited on the surface of the dielectrics of the barrier discharge ignitors. Radicals generated by the discharge can interact with the catalysts on the surface of the dielectric and improve combustion.

Alternatively, short pulses (on the order of nanoseconds) can be used, with very high peak power but modest duty cycle. Special power supplies and power transmission systems are required to generate these pulses. The large power, short duration pulses generate a global discharge, as opposed to the streamers that are generated with the dielectric barrier discharges. These discharges would be very well suited for ignition of the prechamber.

FIGS. 3A-3B show two possible geometries of the electrical configuration of the igniter in the prechamber 40. FIG. 3A shows radial streamers and FIG. 3B shows axial streamers. More specifically, FIG. 3A shows an arrangement with the discharges 44 in the radial direction. In each configuration, there is a dielectric 42 disposed between the central electrode 41 and the ground electrode 43. In the embodiment of FIG. 3A, there is a need for a central electrode 41 in the center of the prechamber 40, which may be undesirable from heat-removal implications. FIG. 3B shows a configuration with axial discharges 45. There is no central electrode 41 in the region with air/fuel. These Figures are meant to be illustrative and other configurations are also possible.

There is a single orifice illustrated in FIGS. 3A-3B. There could be more, and the figures are only illustrative. The combustion gases generated in the prechamber 40 are exhausted through these orifices, at high speed, as the pressure in the prechamber 40 has been substantially increased by the combustion of the fuel/air mixture in the prechamber 40. Also, the fuel injector is not shown. The fuel injector could be axial or radial, or a combination. It is possible to have an electric circuit that is wholly shielded, as opposed to today's conventional spark plugs, with a return through the engine body. The presence of a ground shielding electrode along the entire spark plug, as well as the high voltage wires going to the spark plug, reduce the electromagnetic interference (EMI), which could be a problem with high power sparks. This configuration also eliminates the need for having a resistor in the spark plug to minimize rate of change of currents, as the currents are minimized by the presence of the dielectric barrier.

Because of the temperatures and conditions in the prechamber, the dielectric needs to be high temperature materials, such as ceramics or composites. Low porosity is also desirable.

The discharges generate high values of normalized electric field (i.e., E/n, where E is the electric field and n is the number density of the molecules). At these values, it is possible to generate non-thermal conditions, where the electron temperature is substantially higher than the neutral temperature, generating copious amounts of radicals that hasten the kinetics of the combustion process.

The frequency of operation should be high enough to give multiple pulses during the time for sparking.

Frequencies as low as 10 KHz and as high as 1 MHz could be used in the system. The frequency could be a function of the engine speed and engine load. For example, at the higher speeds, the time for sparking may differ from that at lower speed.

It is possible to integrate the prechamber, chamber and injector, with a coil-on-plug, to further decrease the size of the unit.

There is a second arrangement that is possible by integrating the spark plug with the prechamber. It is possible to operate surface discharges on a dielectric, incorporating the walls of the prechamber into the electrode or the surface used for the discharge. FIGS. 4A-4B show schematics of these topologies. Components with the same function have been given identical reference designators. The main difference between FIGS. 3A-3B and 4A-4B is that in FIGS. 3A-3B, the discharge 44, 45 occurs in the volume, while in FIGS. 4A-4B, the discharge 46, 47 tracks along the surface of the dielectric 42.

This geometry has similar features than that shown in FIGS. 3A-3B. The ground electrode 43 can be used for shielding, thus reducing issues with EMI and enabling the use of high voltage/high currents. In particular, it should be possible to use very high voltage, short pulse (i.e., tens of nanoseconds) discharges, with limited EMI.

Yet another option for the sparking in the prechamber could be sparking without the use of electrodes. In this category, it is possible to use pulsed inductive discharge, microwave discharge, or even laser induced breakdown. The pulsing components could be mounted and integrated into the prechamber/spark unit. In the case of inductive discharge, a dielectric separator between the coil and the prechamber active volume may be needed. In the case of microwave, it would be possible to have the walls of the unit serve as a microcavity, but then the operating frequencies would have to be higher, over 28 GHz. The laser breakdown could be done with a fiber optic coupling into the chamber.

Design of the interface between the prechamber and the main chamber

It is important to enhance mixing and penetration of the jets from the prechamber. FIG. 2A shows the interface between the prechamber 1 and the main chamber 2. As described above, the interface includes one or more orifices. If the geometry of the orifice is a conventional hole, the flow is likely to be choked, that is, gases moving at the sound speed at the exit of the orifice. It is possible to increase the speed of the flow, making it supersonic, by shaping the cross section of the orifice. For example, a converging/diverging orifice can be used in order to increase the momentum and the speed of the jet, increasing the penetration and the mixing (through turbulence) with the air/fuel charge in the prechamber.

The orifice can be shaped using conventional techniques, or it could be made from a number of thin plates with different cross sections. Additive manufacturing could be used, as well as laser drilling, electo-discharge machining (EDM), from one side or from both sides.

The size of the orifices and the number of orifices has a large impact on the performance of the prechamber. Ideally, the prechamber ignition is faster than the flows out of the prechamber, and thus, only combusted, hot products are discharged into the main chamber. This is an approximation, depending on the orifices size and numbers, the spark details, and the volume of the prechamber.

Ideally, the flow out of the chamber should occur in a small fraction of the compression stroke, and ideally, less than 10 crank angle degrees (CAD). Fast discharge allows additional compression and autoignition of those gases in the main chamber that have mixed with the prechamber outflow. High temperatures of the mixed region, coupled with long lasting radicals and hydrogen enable autoignition in those zones, resulting in a large number of ignition “kernels.”

The flow out of the orifices is choked flow, and thus, the flow is independent of the pressure in the prechamber. The prechamber flows are either sonic or supersonic, as described above. Thus, the mass flow rate is easily calculated as the density in the main chamber, the orifice area and the number of orifices. The duration of the outflow is the ratio between the gas mass in the prechamber and the mass flow.

For orifices less than 0.5 mm in diameter and a prechamber of about 1% of the volume of the main chamber, the flow rates are very slow. For orifices on the order of about 1.0-1.5 mm, the flow rates occur in less than about crank angle degrees, measured based on a 1 cm³ prechamber, with 6 1.3 mm diameter orifices. Because of the nature of the choked flows, the duration of the jets is relatively insensitive to the engine speed and load. Lighter loads, including throttle conditions, operate at lower pressures and thus reduced mass flow rates through the orifices after ignition. However, these loads also have lower mass in the prechamber, resulting in near constant duration of the exhaust as a function of pressure. The same argument holds with engine speed; however, as the engine is rotating faster, for a given rate of combustion the duration in crank angle degrees increases (although is some cases, with increased turbulence, combustion rates increase with engine speed). The orifices need to be designed so that at the fastest engine speeds, the duration of the ejection from the prechamber is adequate. Ignition timing may be adjusted, as well as sparking conditions, such as for example, by increasing the power of the ignition and the combustion rate in the prechamber, as well as the ignition timing.

Smaller orifices result in longer duration of the prechamber draining. The penetration depth of the jet in the main chamber depends on the mass flow rate, as the flows in the main chamber are affected by the jets from the prechamber. Supersonic velocities, with larger momentum, result in increased flow disturbance in the main chamber, which enables increased region of impact of the mass ejected from the prechamber.

There is an optimum for the initiation and completion of combustion in the main chamber. If there is a small region of the prechamber that is affected, combustion would be similar to that from a spark, with large regions between the zones that are combusting, in the case of multiple jets. If the mass ejection affects a large region, the impact in terms on temperature increase and increased residuals and radicals will be small, the ignition will be slow in these regions, even though the regions are close to each other, in the case of multiple jets. There is an optimum size and number of orifices where the affected regions have robust combustion initiation, but the regions are not remote from each other, so the flame can reach them fast enough to provide near total combustion reducing the combustion duration in the main chamber. Reduced combustion duration enables increased efficiency (near constant-volume combustion) and helps preventing occurrence of knock.

Having disclosed the configuration and design of the prechamber, other features and benefits are now described.

### Alcohol-Enhanced Prechamber Features

The amount of the fuel delivered to the prechamber is very small, preferably less than 2% of the fuel delivered to the main chamber. Metering this fuel, with a conventional injector, may be difficult. Injectors with much smaller orifices, with fast acting action, such as piezoelectric injectors, could provide the needed fast response. Other injectors could be used, enabled by the use of alcohols in the prechamber. High pressure, relatively high temperature injectors could provide for flash-evaporation of the alcohol.

Alcohol could be injected into the prechamber 1 early in the compression stroke or before as a liquid, and it can vaporize there, scavenging the residuals from the previous combustion cycle. Various alcohols can be used, hydrous or neat methanol or ethanol, or high blends of alcohols and hydrocarbons. Flammability and peak pressure in the prechamber will be increased by removing residuals from the prechamber, improving the combustion in the main chamber.

Cold start emissions can also be improved by the use of a prechamber. In this case, because of the robustness of the ignition process that is provided by the prechamber, less fuel enrichment in the main chamber is needed during cold start. The strong spark in the prechamber can be robust enough to ignite the air/fuel in the prechamber, even in the presence of wall wetting.

Cold start pollutant emissions, and in particular hydrocarbon emissions during a period of 5 seconds or less after the engine has been started, can be reduced by adjusting the equivalence ratio in the main chamber during the cold start. The adjustment of the equivalence ratio in the main chamber may only last a few seconds, such as for example, less than 5 seconds, as it is likely that NOx emissions during this time will be high. Thus, the time of operation with these conditions should be limited. This approach could be used for gasoline alone fueled prechamber operation as well as for alcohol or alcohol-gasoline fueled prechamber operation.

The equivalence ratio within the prechamber can be adjusted across the engine map and for different environmental conditions (such as temperature, for cold start).

More generally, increased fuel/air ratio in the prechamber can be used to adjust the prechamber combustion, affecting the combustion in the main chamber so as to meet various objectives. During conditions with good combustion in the main chamber (for example, medium torque at lower engine speeds), the equivalence ratio in the prechamber can be decreased, by decreasing the alcohol fuel addition. For other conditions, and to avoid knock, higher equivalence ratios in the prechamber are used, including rich conditions, which would result in high burn rates in the main chamber.

The fuel management system can use a lookup table or feedback from engine/exhaust sensors, to adjust the equivalence ratio in the prechamber. The combustion products' composition and temperature can be adjusted and varied across the vehicle operating conditions. A main chamber combustion sensor can be used to determine the amount of alcohol addition.

The adjustment of the equivalence ratio in the prechamber across the engine map can be used to reduce the use of alcohol. The alcohol use in the prechamber could be provided on-demand with the amount depending on engine operating conditions.

Another option is to use the same alcohol-gasoline mixture or pure alcohol in both the prechamber and the main chamber. This may be useful in racing applications, as well as in production vehicles.

An additional opportunity exists, if there is alcohol available, through the reformation of the alcohol by thermal pyrolysis (without the use of oxygen). The reformation can take place in the prechamber, with the use of catalysts on the surfaces of the prechamber. Alternatively, it can take place outside the cylinder. In the case of ethanol, the alcohol pyrolysis products are methane, hydrogen and carbon monoxide. In the case of methanol, the products are hydrogen and carbon monoxide if the catalyst is at relatively low temperature. If the catalyst is hotter, it is possible to create di-methyl ether (DME). DME is highly flammable, and burns with no or minimal generation of soot. The alcohol-based fuel could be introduced into a prechamber that is coated with appropriate catalysts, and the alcohol reforming takes place in the prechamber. Air and optionally additional fuel from the main chamber and even from the prechamber injector, are added to the reformate in the prechamber during the engine compression stroke.

Alternatively, DME could also be injected directly into the prechamber. DME is a liquid at pressure, which would flash-vaporize after injection, preventing wall wetting. The DME could be generated either by pyrolysis of methanol, or stored separately and externally refueled.

As mentioned previously, an important advantage of the use of alcohol injection is that it is significantly less likely that the alcohol will make soot during the evaporation in the prechamber than gasoline. It is likely that the fuel will impinge the internal walls in the prechamber. With heavier hydrocarbons, such as gasoline, there could be substantial generation of soot. For a given prechamber design and equivalence ratio in the prechamber, alcohol can be used so as to provide less soot than would be the case for gasoline.

The increased range of operation and flexibility of an alcohol fueled prechamber relative to a gasoline fueled prechamber, including greater capability for the elimination of soot, may make it possible to robustly provide both high efficiency gains and reduce average NOx emissions in ultra-lean operation to less than 100 ppm over a drive cycle. The NOx level may be low enough to remove the need for NOx exhaust aftertreatment.

Injection of the alcohol before beginning of compression stroke is beneficial, in that the fuel, once vaporized, can help expel residuals from the prechamber, decreasing the diluent concentration. Alcohol is again preferred, in that the volume occupied by the gaseous alcohols is higher than that of gasoline, and thus it is more efficient in scavenging the residuals from the prechamber.

Substantial scavenging can be achieved. For the case of ethanol, with a mass of 46, and a stoichiometric air/fuel ratio of 10, the equivalence ratio of the ethanol in the prechamber (assuming that it is vaporized and at the same temperature as the prechamber walls), would be about 1.1. Thus, for less ethanol injection into the prechamber (to enrich the lean air-fuel mixture from the main chamber), a substantial fraction, but not all, the residuals will be scavenged from the prechamber.

Using torch ignition of the main chamber, a relatively small alcohol fueled prechamber (e.g. less than 2% of the volume of the cylinder at dead center) can be used. The physical separation between the prechamber and the chamber enables large differences in composition, temperature and pressure, which may be short-lived.

Although most previous investigations of prechamber operation have been directed to composition of the air/fuel mixture, it is possible to also have higher temperatures in the prechamber at inlet valve closing. Higher temperatures increase ignitability. However, they decrease the amount of fluid (air and fuel) in the prechamber for a given pressure, and thus there should be an optimal temperature in the prechamber that results in best combustion in the main chamber. Higher temperatures in the prechamber result in faster combustion, higher combustion temperature and larger pressures, which results in faster ejected flows, but the total mass of the jet is decreased because of lower amounts of air/fuel in the prechamber.

### Other Engine Fuels

The alcohol-enhanced prechambers described herein can be with natural gas engines, which are defined as engines with natural gas in the main chamber. Natural gas engines are in some cases difficult to ignite, for example, due to poor air/fuel mixing. The proposed approach can be attractive for igniting stoichiometric and lean natural gas engines. The relatively large size of the source of ignition in the main chamber may also allow SI operation with larger cylinder sizes. The air/methane are premixed, thus the gas that enters the prechamber through the orifices, from the main chamber, driven by the compression cycle, contains both air and methane.

The fuel in the prechamber can either be 100% alcohol or a high concentration alcohol-gasoline mixture, such as greater than 70% alcohol by volume.

An alcohol-enhanced prechamber approach along with on-demand alcohol octane boosting could significantly increase the efficiency of stationary as well as vehicular engines using natural gas and other sources of gas of which methane is the main constituent.

The use of an alcohol enhanced prechamber can also increase the RPM at which at natural gas fueled, gasoline fueled, alcohol fueled or propane fueled engine can operate. It can also enable use of a higher compression ratio or more turbocharging by increasing knock resistance. The increase in knock resistance can result from faster flame propagation and a large region ignited region.

Alcohol-enhanced prechambers with or without on-demand alcohol octane boosting can also be employed with propane fueled engines

### Modeling Calculations of Prechamber Operation

In order to determine the modes of operation of alcohol-enhanced prechamber operation, the flame speeds of methanol and ethanol addition to a lean fuel/air mixture, at various total equivalence ratios, have been calculated. Illustrative calculations have been performed using methane-alcohol mixtures (rather than gasoline-alcohol mixtures) to facilitate the calculations, which would have been computationally challenging if gasoline-alcohol were used instead. These calculations show that substantial improvements in flame speed can be obtained.

These improvements can enable a richer fuel/air mixture in the prechamber and more rapid movement of the ignition front away from the prechamber.

Modeling was performed assuming that the equivalence ratio in the main chamber is 0.5, and that methane was used as the main fuel in the prechamber. Because only fuel is being injected in this case, the equivalence ratio increases, approaching or even exceeding stoichiometric.

Table 1 shows chemical kinetics based calculations of the laminar flame speed (cm/s) and the adiabatic flame temperature, assuming that air/methane mixture is introduced into the prechamber during the compression cycle (when gas from the main chamber is pushed into the prechamber) as a means to simulate an alcohol-gasoline mixture, with a methane equivalence ratio (phi) of φ=0.5, and methanol is added to the mixture. It is assumed that the pressure is 10 bar and the unburnt air/fuel mixture temperature is 640 K. The prechamber equivalence ratio increases because of the introduction of methanol into the prechamber.

In the case of no methanol addition, the laminar flame speed is about 11 cm/s, probably too low to support robust combustion and avoid misfire. Even 10% methanol addition increases the laminar flame speed to those comparable to stoichiometric air/methane, with a substantial increase in the adiabatic flame temperature. Even rich operation (φ=1.25) does not result in substantial decrease in flame temperature. Very robust combustion in the prechamber should occur under methanol addition. The increased combustion temperature with increasing methanol addition should result in faster, hotter jets for improved combustion in the main chamber.

TABLE 1
Flame speed and adiabatic flame temperature for
different amounts of methanol addition to air/methane
with φ = 0.5. T = 640 K, 10 bar.

| Methanol | methane | | | adiabatic flame |
|---|---|---|---|---|
| addition | phi | total phi | flame speed | temperature |
| 0 | 0.5 | 0.5 | 10.5 | 1741 |
| 0.1 | 0.5 | 0.65 | 35.4 | 2017 |
| 0.2 | 0.5 | 0.8 | 60.8 | 2250 |
| 0.3 | 0.5 | 0.95 | 77.7 | 2425 |
| 0.4 | 0.5 | 1.1 | 86.4 | 2453 |
| 0.5 | 0.5 | 1.25 | 82.4 | 2359 |

Table 2 shows the laminar flame speed and adiabatic flame temperature in the case of ethanol addition, for comparable conditions as shown in Table 1 for methanol. It is interesting to note that the adiabatic flame temperatures are very similar for methanol and ethanol for comparable total equivalence ratios.

The laminar flame speed of methanol is substantially higher than that for ethanol for comparable total equivalence ratio, by ˜20%. Also, as the equivalence ratio increases over 1, the laminar flame speed in the case of ethanol decreases rather quickly with increasing equivalence ratio. However laminar flame speed remains approximately constant for the case of methanol.

Thus, in some embodiments, methanol may be a substantially better fuel additive to the prechamber than ethanol. However, ethanol could still provide a significant advantage relative to using gasoline in the prechamber. The flame speed of methanol and ethanol (for stoichometric conditions) is about 20% and 10% greater than gasoline, respectively. Even under conditions where the alcohols are not the only fuel, the flame speed of alcohol addition is higher than that of gasoline. The increased flame speed improves dilution tolerance and decreases soot formation. In addition, with wall wetting in the prechamber, the deposited alcohol is likely to help clean the surfaces, maintain them at lower temperatures due to the higher evaporative cooling. This is beneficial for preventing soot formation through fuel coking/pyrolysis.

TABLE 2
Flame speed and adiabatic flame temperature for different
amounts of ethanol addition to air/methane with
φ = 0.5. T = 640 K, 10 bar.

| Ethanol | methane | | | adiabatic flame |
|---|---|---|---|---|
| addition | phi | total phi | flame speed | temperature |
| 0 | 0.5 | 0.5 | 10.5 | 1741 |
| 0.05 | 0.5 | 0.65 | 33 | 2017 |
| 0.1 | 0.5 | 0.8 | 55.5 | 2255 |
| 0.15 | 0.5 | 0.95 | 70 | 2437 |
| 0.2 | 0.5 | 1.1 | 72.4 | 2468 |
| 0.25 | 0.5 | 1.25 | 57.9 | 2355 |
| 0.3 | 0.5 | 1.4 | 37.5 | 2243 |

Because of the high temperatures during the combustion process, the prechamber chemistry has been modeled using a constant volume, constant enthalpy model, with products being in thermal equilibrium. It is assumed that the chamber is constant volume, meaning that the chemistry is fast compared with the fluid dynamics, which will result in pressure relief in the prechamber. The model is useful to determine the characteristics of the prechamber, even though it is approximate.

In this modeling, fuel and air are used in the main chamber, and additional alcohol, which in this embodiment is methanol, is used in the prechamber. The residuals in the prechamber are ignored. The species that are assumed in the prechamber for calculation of the thermal equilibrium are H₂, H, O₂, O, OH, HO₂, H₂O, N₂, N, CH₄, CH₃OH, CO and CO₂. It is assumed that no carbon is formed.

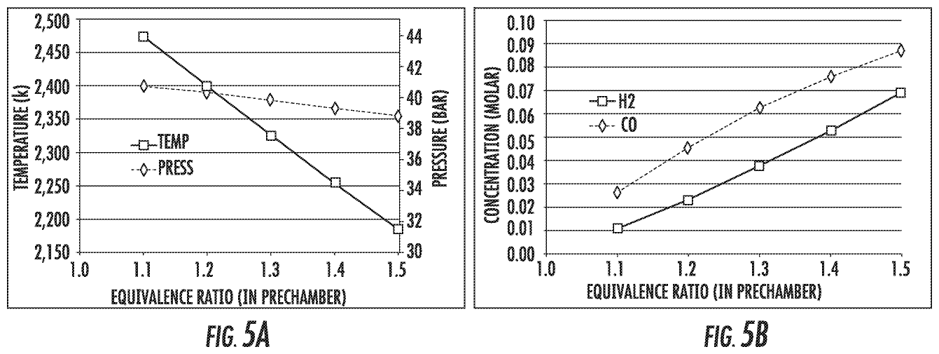

The results for an alcohol fueled prechamber are shown in FIGS. 5A-5B, as a function of the equivalence ratio, where equivalence ratio is defined as the fuel to air ratio divided by the fuel to air ratio for a stoichiometric fuel-air mixture. It is assumed that CH₃OH:CH₄ is 1.5:1, and the total amount of fuel is adjusted to match the desired equivalence ratio. Although it is assumed that the hydrocarbon is methane, the results do not change substantially if other hydrocarbons are used. It is assumed that the initial conditions are 10 bar and 640 K, typical conditions for sparking in SI engines. The prechamber can be operated at an equivalence ratio of 1.1 with a temperature greater than 2400 K and at an equivalence ratio of 1. 5 with a temperature greater than 2100 K.

The pressure in the prechamber, assuming very fast reactions, increased to about 40 bar, while the temperature is about 2300 K, and decreases with increasing equivalence ratio. As shown in FIG. 5B, the hydrogen and CO fraction increases with increasing equivalence ratio, to about 10%. It should be noted that there are radicals formed in the reaction, both OH and H, at about 0.01%. O radicals are a much lower concentration, as most of the oxygen is bound with the carbon or the hydrogen.

Other expected radicals, such as CH₃, are in concentrations much lower than those of H and O radicals. The hot products, such as syngas, are ejected at high speed from the prechamber, with substantial amount of enthalpy and radicals. Selection of the equivalence ratio in the prechamber is a tradeoff between decreasing temperature, which causes slower reactions, and lower radicals, and decreasing hydrogen rich gas content in the ejected fuel.

The impact of the combustion of the main fuel with these parameters determines where the optimum lies. Under one set of conditions, which include engine load and speed, one equivalence ratio in the prechamber is used, while in a different one, a different set of conditions is used. For example, at high engine speeds, where fast combustion is desired, equivalence ratios near stoichiometric may be preferred, while at low engine speed, increased equivalence ratios, with higher hydrogen and CO, may be preferred, resulting in stable combustion in the main chamber with increased dilution.

The use of prechamber with a strong spark is advantageous in that the combustion of the air/fuel mixture in the prechamber is robust, not sensitive to the actual equivalence ratio in the prechamber. Thus, the challenge of metering the additional fuel in the prechamber is eased.

### Engine Operation

The preferred alcohol-enhanced prechamber operation could employ the use of a very small amount of alcohol, such as between 1% and 2% of the gasoline used by volume and in certain embodiments, lower than 1%, to provide a rich alcohol/air mixture that is ignited in the prechamber and ignites the main chamber. This is particularly important when alcohol is not available from onboard fuel separation and/ or where alcohol is not being used for on-demand octane boost.

The alcohol component of the equivalence ratios for the prechamber, the cylinder and /or the total equivalence ratio (the equivalence ratio of the fuel-air composition in the prechamber plus the main chamber) can be varied across the engine map, as described above. These adjustments can be used to reduce and preferably provide minimization of alcohol use.

In addition to minimizing the alcohol requirement for the prechamber operation by varying the amount of alcohol based on the region in the torque-speed space at which the engine is operating, alcohol use could also be minimized by optimizing the tradeoff between prechamber temperature and equivalence ratio as described previously.

A further means of reducing the alcohol use could be employed, where a directly injected alcohol-gasoline mixture with a varying ratio of alcohol to gasoline could be used in the main chamber.

The minimization of alcohol use could be obtained by both closed loop control and by open loop control using a look up table. Thus, the alcohol use in the prechamber can be viewed as “on-demand alcohol burn boost”.

While methanol provides higher flame speed than ethanol, ethanol used in a somewhat larger amount than methanol could provide sufficient performance and efficiency benefits. Further, the use of ethanol could be easier to deploy in the US.

The alcohol-enhanced prechamber can enable an ultra-lean mixture of gasoline and air, such as for example, an equivalence ratio of 0.5, corresponding to lambda=2, in the main chamber without misfire and with a high rate-of-heat release (ROHR). The ultra-lean mixture keeps NOx levels due to combustion in the main chamber at very low levels (e.g. less than 100 ppm) and provides higher efficiency operation through lower heat losses, and at light loads, improved thermodynamic efficiency and reduced pumping losses.

In certain embodiments, it is preferred that NOx levels from the ultra-lean engine be lower than diesel vehicle emissions following urea-SCR aftertreatment and preferably comparable to the very low emissions from spark ignition gasoline engines following aftertreatment by the three way catalyst.

If needed, additional reductions in NOx emissions could be obtained by use of a lean NOx trap in the exhaust system. Hydrogen-rich gas produced by reformation of alcohol, especially methanol, could be well suited to regeneration of the trap. Ethanol could also be used. The NOx reduction requirements of the trap could be lessened by the already low NOx emission levels from ultra-lean operation, thereby reducing precious metal catalyst requirements and cost. Alcohol use, either through conversion to hydrogen-rich gas or directly utilized, may also be useful in other exhaust aftertreatment applications.

In certain embodiments, it is also preferred that ultra-lean operation be used at both low and high torque in order to minimize NOx emissions and to maximize efficiency.

Alternatively, the alcohol prechamber could be used to enable significantly higher EGR with stoichiometric fuel/air operation. Heavy EGR could provide a substantial reduction to already low NOx levels in stoichiometric gasoline engine operation with a three way catalyst and could also provide a modest increase in efficiency (˜3-8%). Hot heavy EGR (either internal or external) would be used at low loads and could be reduced or eliminated at high loads.

With the use of high compression ratio operation, such as for example, a compression ratio of 14, enabled by an ultra-lean fuel-air ratio, the ultra-lean operation could provide an efficiency gain of 20-25% over a conventional naturally aspirated engine in a light duty or delivery truck driving cycle where most of the driving is at low torque.

Without some additional change in the engine operation, the size of the ultra-lean engine would need to be increased by a factor of around two to provide the same torque as would be obtained in a naturally aspirated stoichiometric fuel/air ratio engine. This increase in size would reduce the efficiency gain.

However, the required increase in size could be largely or completely avoided by upspeeding (using a higher ratio of engine RPM to wheel RPM) gearing to provide more power from the engine and to use the increase in power to provide more torque to the wheels than would be the case without upspeeding.

A variable shifting schedule could be used to compensate for a faster engine while the wheels are rotating at a given speed. For example, increasing the RPM by a factor of 1.5, could reduce the required increase in the size of the ultra-lean engine to a factor of 1.3 rather 2.0.

Upspeeding can thus be used to make up for the increased dilution in the engine, without the need for increased boosting. If the ultra-lean engine is being used as an alternative to a diesel engine, where torque and power at the wheels are the key parameters by which engine performance is compared, this tradeoff would be appropriate. In this case, upspeeding gearing could be particularly attractive for minimizing or eliminating an increase in engine size resulting from ultra-lean engine operation.

A small amount of turbocharging could also be used to make up for the increase in engine size resulting from ultra-lean operation.

The 20-25% efficiency gain could be increased by turbocharging to enable engine downsizing relative to a naturally aspirated engine. Knock in the main chamber could be prevented by the prechamber enabled ultra-lean operation and vaporization cooling from gasoline direct injection. With this downsizing, the efficiency gain relative to a naturally aspirated gasoline engine could be increased to around 25-28% by use of a downsizing of 30-40% which is typical of a GTDI engine. This efficiency gain for a light duty type driving cycle is similar to a diesel engine.

A small alcohol requirement, such as 1-2%, for the prechamber could be provided by external refill of a smaller tank that is separate from the gasoline tank. A typical alcohol use in a car over a year would be 3-4 gallons. The required refill interval could be kept above once every 5,000 miles and would typically be around once every 10,000 miles.

Alternatively, the alcohol could be provided by separation from a low concentration alcohol-gasoline mixture. Ethanol could be provided by separation from E10 in the US and the methanol could be provided by separation from a gasoline-methanol mixture such as M15, which is 85% gasoline, 15% methanol, that is used in China. Another option, which could be used for prechamber operation only, is separation from M3 operation that is allowed by regulations in the US and Europe.

The increased amount of alcohol that could be made available from alcohol separation from gasoline could provide further robustness and flexibility for alcohol-enhanced prechamber operation.

These engines with alcohol used only for the prechamber and direct injection or open-valve port fuel injection of gasoline in the main chamber could potentially provide comparable efficiency gains and torque to diesel engines with roughly the same power. They would be of the same physical size but would not require the high strength material that is used in a diesel engine.

Because of the ultra-lean operation with a homogeneous mixture of fuel and air in the main chamber, the engine-out emissions of NOx would be significantly lower than a diesel engine. No or a very modest exhaust treatment system would be required. By use of an optimized combination of gasoline port fuel injection and direct injection in the main chamber where use of DI gasoline is minimized, the engine-out particulate emissions would be much lower than from a diesel engine. In addition, a particulate filter would not be required.

Downsizing might also be enabled by switching to stoichiometric operation which enables the use of a three way catalyst at the highest value of torque. However, this would require a more complicated and expensive control system to adjust the air/fuel ratio levels and to treat higher NOx emissions.

An optimized prechamber engine could thus provide the ultra-lean operation and high compression ratio efficiency advantages that are provided by a diesel engine along with greater downsizing. In contrast, downsizing in diesel engines could be limited by emissions issues. Relative to a diesel engine, the engine plus urea —SCR and NOx exhaust system cost could be substantially reduced by a simpler and lower exhaust treatment system; and emissions would be lower.

If operation at high load is ultra-lean, it is necessary to provide substantial amounts of air at higher pressures, in order to maintain desired BMEP. The additional dilution helps for knock mitigation, but the high air temperature from turbocharger compression contributes to knock tendency of the engine. To minimize the amount of antiknock agent used in the cylinder, it may be useful to have an effective intercooler downstream from the air compressor. It may be advantageous to use an electrical supercharger in conjunction with the turbocharger.

Table 3 shows illustrative parameters for light duty vehicles that use ultra-lean turbo gasoline engines that employ an alcohol prechamber. They are also illustrative of medium duty vehicles, such as delivery trucks, that operate with a light duty drive cycle where most driving is at low torque. A direct injector is used to introduce alcohol in the prechamber and direct injection or open-valve port fuel injection is used for gasoline in the main chamber. The downsizing and efficiency gains are relative to naturally aspirated engine with a compression ratio of 10.

The non-downsized option uses gearing upspeeding to prevent “upsizing”, which would be required to increase engine size (displacement) to compensate for ultra-lean operation instead of stoichiometric engine operation. The use of upspeeding removes the need for preventing upsizing by boosting from the turbocharging. With the use of high compression ratio, this option could provide a 20-25% efficiency gain

Downsizing without upspeeding gearing using pressure boosting from turbocharging enabled by the greater knock resistance due to vaporization cooling from direct injection of gasoline could provide an additional efficiency gain of around 5%. Alcohol octane boosting could provide additional knock resistance to enable greater downsizing at the expense of a greater alcohol requirement.

TABLE 3
Illustrative parameters for ultra-lean turbo
gasoline engines using an alcohol prechamber

| | Pressure | Compression | Efficiency | Alcohol |
|---|---|---|---|---|
| | Boost | Ratio | Gain | Use |
| Same size as stoich nat. | | 14 | 20-25% | ~1% |
| aspirated engine by using | | | | |
| upspeeding gearing; | | | | |
| also high compression | | | | |
| ratio | | | | |
| 30% downsized using | 1.7 X | 14 | 25-30% | ~1% |
| turbocharging | | | | |
| with direct gasoline | | | | |
| injection | | | | |

The downsized engines in Table 3 could be particularly effective in places where there is an effort to reduce use of light duty and medium duty diesel engines and/or where low concentration alcohol-gasoline mixtures, from which alcohol could be separated, are not used. European cities are an example. The amount of alcohol use for prechamber operation could be less than the urea use for urea-SCR operation. Methanol may be the preferred alcohol because of its higher flame speed and reduced propensity to soot relative to ethanol.

The engine for the ultra-lean operation could be a factory modified spark ignition gasoline engine that would not need the strengthening required for diesel operation.

For the ultra-lean options to be attractive, it is important that the vehicular NOx emissions be at least as low, if not lower than emissions with present urea-SCR technology.

If additional alcohol is available, it could be used to provide greater capability of the prechamber and/or increased knock resistance. The availability could be provided by alcohol fueling at fleet stations and/or by onboard separation from a gasoline-alcohol mixture. Greater prechamber capability could also be provided by a better ignition source using the plasma sources described below.

Another set of options for light duty vehicles could be to use alcohol prechamber operation to enable heavy EGR operation in a vehicle that uses stoichiometric operation. For an alcohol prechamber engine that uses stoichiometric operation with downsizing enabled by direct injection of gasoline and a conventional compression ratio of around 10, heavy EGR could increase efficiency by around 5%.

With use of on-demand alcohol octane boost to increase the knock free compression ratio to around 14 and no increase in downsizing relative to a GTDI (gasoline turbocharged direct injection) engine, the efficiency gain would be 10-12% relative to a GTDI engine and around 20-24% relative to a naturally aspirated engine. This could provide an efficiency gain close to a diesel engine without the need for the higher strength material needed for a diesel engine.

In addition to fuel efficiency on an energy basis that is around or better that of a diesel, gasoline engine NOx emissions could be reduced by more than a factor of 50 relative to diesel engines that use state of the art urea-SCR exhaust treatment systems.

Table 4 shows illustrative parameters for heavy EGR stoichiometric fuel/air ratio engines using an alcohol prechamber. The efficiency gain is relative to a conventional naturally aspirated engine with a compression ratio of 10. The knock resistance required for compression ratio of 14 operation and GTDI type downsizing could be provided by modest on demand alcohol octane boosting while gasoline is port fuel injected in the main chamber.

On-demand alcohol octane boosting with additional turbocharging, additional downsizing, additional alcohol use and use of a diesel like engine material strength could provide an efficiency gain that is greater than a diesel along with ten times lower NOx emissions than a state of the art diesel vehicle emissions.

It could lower NOx emissions to a level below the requirement for “ultra low NOx emissions” for trucks that are being contemplated for the California Air Resources Board and the US EPA. This type of engine could be attractive for pickup and medium duty trucks using alcohol separation in the US.

TABLE 4
Illustrative parameters for heavy EGR turbo gasoline engines using
an alcohol prechamber and offering ultra low NOx emissions

| | Pressure | Compression | Efficiency | Alcohol |
|---|---|---|---|---|
| | Boost | Ratio | gain | use |
| Nat Aspirated (NA) | — | 10 | ~5% | ~1% |
| NA, High Compression | | 14 | 10-12% | ~1% |
| Ratio Using DI gasoline | | | | |
| 40% Downsized using DI | 1.7 | 10 | 15-17% | ~1% |
| gasoline | | | | |
| 40% downsized with high | 1.7 | 14 | 20-24% | ~5% |
| compression ratio and | | | | |
| PFI alcohol boost | | | | |
| 60% downsized using | 2.5 | 14 | 25-35% | ~10% |
| additional alcohol boost | | | | |

As shown in Table 4, use of around 1% alcohol could enable ultra low NOx operation in a high compression ratio, heavy, EGR naturally aspirated engine that would have around the same efficiency gain as present GTDI engines. Use in a conventional compression ratio, downsized engine could provide an efficiency gain of 15-17%, which may be about 5% greater than present GTDI engines.

With greater alcohol use, which could be provided by fuel separation from E10 or M15, efficiencies that are comparable to or greater than diesel engines could be obtained along with ultra low NOx operation.

Ultra-lean boosted operation, with Miller cycle, can provide efficiencies close to those of a diesel engine by increasing efficiency through a higher expansion ratio. Use of a Miller cycle can increase thermodynamic efficiency with a lower knock resistance requirement than increasing the geometric compression ratio. The prechamber can be used to provide improved dilution tolerance, addressing one of the main concerns with lean boost operation, namely, controlling the NOx emissions. In lean operation, the exhaust temperatures are low and it is challenging to remove the NOx with a lean NOx trap or SCR. However, the prechamber could enable operation with ultra dilute operation, such that engine-out emissions are low enough that do not require aftertreatment. If desired, the NOx emissions could be further decreased using either with SCR, requiring very small amounts of urea, passive-active ammonia SCR or a lean NOx trap.

The low temperature and pressure of the exhaust can make operation of the turbocharger difficult at conditions of high load. Under heavy load, the boosting system can be augmented by the use of electric boosting (supercharger), or with the use of an e-turbo or similar electric-assisted turbochargers. At low loads, the turbine provides sufficient power for compressing the air. At heavy loads, where the exhaust is unable to drive the turbine alone, electrical assist is used.

Ultra-lean gasoline operation using an alcohol prechamber could be attractive for long haul heavy duty trucks. These vehicles operate for a high fraction of time at high torque.

At high torque, the ultra-lean gasoline engine with the same torque as a diesel engine would have an efficiency that is comparable to the diesel engine due to low temperature operation and high compression ratio. The engine-out NOx emissions could be around 10 times lower than those from a diesel engine with a state-of-the-art SCR exhaust treatment system using urea. The alcohol use for the prechamber could be less than the 2-6% urea use for the SCR exhaust treatment.

The cost of the engine and exhaust treatment system would be substantially less than that of a diesel engine. In addition, the higher power resulting from the higher RPM of a spark ignition engine could provide greater capability for hill climbing and passing.

It should be noted that diesel engines operate with a larger amount of dilution, but in the case of the spark ignition (SI) gasoline engine, the dilution is air, while in the case of diesel, at high load it is mostly EGR. The SI engine would thus operate with higher thermodynamic efficiencies resulting from the effect of dilute operation.

Additional performance or efficiency gains of the ultra-lean engine could be possible by more turbocharging, which could require more knock resistance. The increased knock resistance would be provided by alcohol introduction into the main chamber.

This alcohol could be provided by a relatively small number of service stations located along long haul truck routes and at fleet service stations. Onboard separation of alcohol from alcohol-gasoline mixtures could also play a role in providing this alcohol.

Ultra-lean engines in long haul heavy duty could also benefit from improved ignition from the plasma sources described above.

The utilization of heavy EGR with alcohol boosted stoichiometric engine operation could potentially provide even larger emissions reduction but could require considerably higher alcohol use.

Gasoline engines using direct injection produce 10 to 100 times more small particulates than port fuel injected engines. These particulates are a health concern because they lodge in the lung. They are regulated in Europe and regulations are anticipated from the US EPA and the California Air Resources Board (GARB).

By using direct injection for the prechamber fueling and port fueled injection for fueling of the main chamber, particulate emissions relative to present direct injection gasoline engines could be greatly reduced. The amount of fuel provided by direct injection, and thus the amount of direct injection-generated particulates, is typically only a few percent of the fuel provided by the port fuel injection used in the main chamber. Moreover, particulate emissions from alcohol are lower than particulate emissions from gasoline. Any particulates generated in the prechamber are likely to combust in the main chamber, which has an abundance of oxygen.

Lean operation also results in decreased particulates, as it is more likely that particulates produced during the combustion can be burned by the excess oxygen.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. An engine that uses a prechamber to ignite a fuel air mixture in at least one cylinder where the prechamber is fueled with alcohol alone or with an alcohol-gasoline mixture; and where the fuel in the cylinder is alcohol alone, alcohol and gasoline or gasoline alone.

2. The engine in claim 1 where the fuel in the cylinder is gasoline alone or is a mixture of alcohol and gasoline where the alcohol in the mixture is in a lower concentration than the fuel in the prechamber.

3. The engine in claim 2 where the equivalence ratio in the prechamber is varied as a function of operating conditions in the cylinder.

4. The engine in claim 2 where the use of a higher concentration of alcohol in the prechamber, including 100% fueling of the chamber with alcohol, reduces the soot produced in the prechamber.

5. The engine in claim 2 where the use of alcohol in the prechamber enables engine operation at higher equivalence ratio than would be allowed by a combustion stability requirement if the alcohol-gasoline mixture or gasoline alone which is used in the cylinder were used in the prechamber.

6. The engine of claim 2 where the engine operates at a higher level of combustion stability limit allowed EGR by use of a higher concentration of alcohol in the alcohol-gasoline mixture in the prechamber, including the use of alcohol alone, relative to the concentration of alcohol in the cylinder including the use of no alcohol in the cylinder.

7. The engine of claim 2 where the alcohol used in the prechamber is entirely provided by onboard separation from a gasoline-alcohol mixture.

8. The engine of claim 2 where the fuel in the prechamber is ignited by a plasma source that is different from a spark plug.

9. The engine of claim 2 where the fuel in the prechamber is ignited by silent discharge.

10. The engine in claim 2 where the fuel in the prechamber is ignited by a corona discharge.

11. An engine that uses a prechamber to ignite a fuel air mixture in at least one cylinder where the prechamber is fueled with alcohol alone or with an alcohol-gasoline mixture; and where the fuel in the cylinder is gasoline alone or is a gasoline-alcohol mixture with a lower concentration of alcohol than the fuel in the prechamber;
and where engine is operated at a leaner mixture or uses heavier EGR which is determined by a combustion stability limit than would be the case if the concentration of alcohol in the prechamber were not higher than in the cylinder.

12. The engine of claim 11 where the engine is operated at a leaner mixture.

13. The engine of claim 12 where the operation of the engine at higher RPM is employed to compensate for the lower power produced by lean operation.

14. The engine of claim 11 where the alcohol is entirely provided by onboard separation from an alcohol-gasoline mixture.

15. The engine of claim 11 where alcohol is introduced on-demand into the cylinder to increase knock resistance.

16. The engine of claim 15 where the alcohol is ethanol.

17. The engine of claim 15 where the alcohol is methanol.

18. An engine having at least one cylinder and a prechamber, wherein the prechamber uses alcohol alone or an alcohol-gasoline blend and where a different fuel is used in the cylinder.

19. The engine of claim 18 where the alcohol-gasoline blend has an alcohol concentration that is greater than 70%.

20. The engine of claim 18 where natural gas is used in the cylinder.

21. The engine of claim 18 where propane is used in the cylinder.

22. The engine of claim 18 where the use of the prechamber increases the amount of EGR that can be used in the engine.

23. The engine of claim 18 where the use of the prechamber increases the RPM at which the engine is operated.

24. The engine of claim 18 where the use of prechamber increases the compression ratio at which the engine can be operated.

25. An engine that uses a prechamber to ignite a fuel air mixture in at least one cylinder where the prechamber is fueled with alcohol alone, with an alcohol-gasoline mixture or with gasoline alone; and
where the prechamber equivalence ratio is adjusted based on engine temperature so as to reduce emissions of hydrocarbons during a cold start period of 5 seconds or less.

26. The engine of claim 25 where the prechamber equivalence ratio adjustment reduces the amount of enrichment in the engine cylinder that would otherwise be employed.

27. The engine of claim 25 where the prechamber employs a turbulent jet ignition injector that uses a converging/diverging nozzle to achieve supersonic flow of the prechamber gases.

28. An engine that uses a prechamber to ignite a fuel air mixture in at least one cylinder where the prechamber is fueled with alcohol alone, with an alcohol-gasoline mixture or with gasoline alone; and
where the prechamber is ignited by an electrodeless discharge or by a high voltage discharge where arc does not occur.

29. The engine of claim 28 where fuel-air mixture in the prechamber is ignited by a microwave discharge.
